(19) United States
(12) Patent Application Publication
(10) Pub. No.: US 2003/0035097 A1
(43) Pub. Date: Feb. 20, 2003

(54) Method and apparatus for locating object by using laser range finder

(76) Inventors: Robert Lai, Taichung (TW); Pie-Yau Chien, Taichung (TW); Jui-Feng Huang, Taichung (TW)

Correspondence Address: WILDMAN, HARROLD, ALLEN & DIXON, 225 WEST WACKER DRIVE, CHICAGO, IL, 60606, US

(21) Appl. No.: 10/227,906

(22) Filed: Aug. 26, 2002

Related U.S. Application Data
(63) Continuation-in-part of application No. 09/676,977, filed on Oct. 2, 2000, now abandoned.

(51) Int. Cl. G01C 3/08

(52) U.S. Cl. 356/5.01

(57) ABSTRACT

A method and an apparatus for locating an object by using a laser range finder are disclosed, and more particularly relates to a method and an apparatus that can increase distance and accuracy of measuring object without increasing laser emitting power. Since noise is existent randomly, through the statistics theorem, it is known that an accurate distance between the laser range finder and the measured object can be measured and obtained by repeatedly performing measurements and accumulatively adding the result obtained from each measurement. Hence, by utilizing the present invention, an accurate distance between the laser range finder and the measured object can be measured without increasing the emitting laser power, and even if the measurement is performed under a noisy situation.

### CORSS REFERENCE TO RELATED APPLICATION

This application is a continuation-in-part of U.S. patent application Ser. No. 09/676,977 filed Oct. 2, 2000, which is hereby incorporated by reference.

### BACKGROUND OF THE INVENTION

1. Field of the Invention

The present invention relates to a method and an apparatus for locating object by using laser range finder, and more particularly relates to a method and an apparatus that can increase the distance and accuracy for measuring the target without increasing laser emitting power.

2. Background of the Related Art

The laser range finder is one of important instrument for measuring the distance from an object. The conventional laser range finder emits a laser light pulse of about 10 ns to 20 ns in pulse width to an object by utilizing a pulse type laser emitter, and then a laser receiver is used to receive the laser light pulse reflected from the object, wherein the distance between the laser range finder and the object can be calculated according to the following formula (1),

T_{d}=2L/C (1)

wherein L is the distance between the laser range finder and the object, and C is the light speed, and T_{d} is the time difference between the time of emitting the laser light pulse and that of receiving the reflected laser light pulse. According to formula (1), the distance between the laser range finder and the object can be accurately computed and obtained. In the prior art, for accurately measuring T_{d}, it is necessary to increase the laser emitting power as much as possible, or to eliminate the noises that are caused by sunlight and sunbeam and received by the laser receiver as much as possible. U.S. Pat. No. 3,644,740 discloses a receiving circuit in which the signal noise ratio is improved by controlling a voltage bias of the receiving circuit for obtaining a false alarm. U.S. Pat. No. 4,569,599 discloses a counting control technique for detecting the range signal. U.S. Pat. No. 4,770,526 discloses a technique to increase the accuracy of measuring the object distance by amplifying time delay signal. In addition, a digital distance measuring technique disclosed in U.S. Pat. No. 3,959,641 is used to decrease the threshold voltage of the laser receiver for increasing the distance of measuring the object.

For coping with different situations, U.S. Pat. No. 5,612,779 further discloses a design of automatically adjustable threshold voltage in a laser receiver. In this prior art, the threshold voltage of the laser receiver is varied according to the change of the signal intensity reflected from the object, so as to set a threshold voltage to some value between received noise and reflected laser light pulse in different situations. The major efficacy of this prior art is to increase the detection distance and accuracy.

### SUMMARY OF THE INVENTION

In view of the background of the invention described above, since the operation frequency of IC currently used is getting higher, and the area of chip is also increased due to the technology progresses of semiconductor process and IC design, the voltage drop caused by semiconductor components of IC in operation becomes larger, and meanwhile, the high operation frequency of semiconductor components generates severe power noise that interferes and pollutes the regular operation signals of circuit and power supply, thus affecting the operation performance of IC and the signal accuracy.

It is the principal object of the present invention to provide a method and an apparatus for locating an object by using a laser range finder. In order to accurately measure a distance from an object without increasing the emitting laser power, the method provided by the present invention performs a plurality of measuring processes, and each of the measuring process include s emitting a light pulse; receiving a reflected light pulse; transforming the reflected light pulse into digital data and accumulating the digital data by addition. Since noise is randomly existent, according to the statistics theorem, it is known that a maximum value exits in an accumulated measurement result after the plurality of measuring processes are performed, wherein a distance corresponding to the maximum value in the accumulated measurement result is the distance between the laser range finder and the measured object. Therefore, by increasing the number of measuring processes, a more accurate accumulated measurement result can be obtained even in the measurement situation having severe noise.

In accordance with the aforementioned purpose of the present invention, the present invention provides a method and an apparatus for locating an object by using a laser range finder. First, a plurality of rounds of measurement are performed for obtaining a plurality of measurement results, wherein each of the rounds of measurement includes: performing an emitting step to emit a first laser light pulse; performing a receiving step to receive a photo signal including the laser light pulse and a plurality of noises; performing a conversion step which includes: transforming the photo signals into a serial signal; and transforming the serial signal into a plurality of digital signals; and performing a storage step to store the plurality of digital signals as a measurement result; and then an accumulation step is performed to accumulate the plurality of measurement results for obtaining an accumulation measurement result; and thereafter, a determination step is performed to determine a distance between the object and the laser range finder, wherein the distance corresponds to an accumulated digital data having a maximum value in the accumulated measurement result.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart showing a process of an embodiment of the present invention.

FIG. 2 is a waveform diagram showing the external photo signal received by the laser receiver.

FIG. 3 is a diagram showing the digital data obtained by transforming the photo signal shown in FIG. 2.

FIG. 4 is a list showing the plurality of digital data stored in the storage device according to FIG. 1.

FIG. 5 is a diagram showing the plurality of digital data obtained and stored in the storage device sequentially for each of eight measurements after sequentially repeating the emitting step, the receiving step, the data conversion step, the data storage step and the accumulation step for eight times according to FIG. 1.

FIG. 6 is a flow chart showing a preferred embodiment of the present invention.

FIG. 7 is a diagram showing the connection relationship among modules in a preferred embodiment of the apparatus provided by the present invention.

### DETAILED DESCRIPTION OF THE INVENTION

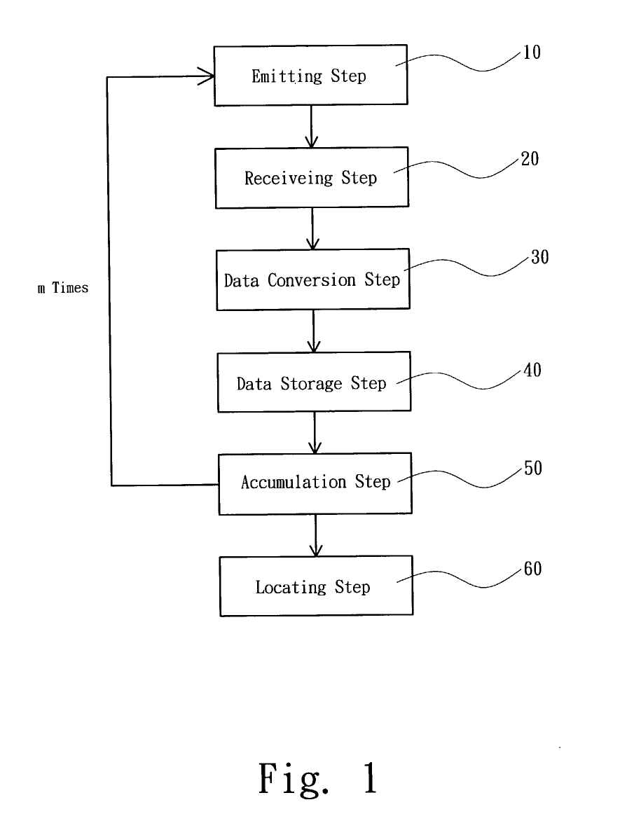

FIG. 1 is a flow chart showing an embodiment of the invention. As shown in FIG. 1, the method of the invention includes an emitting step 10, a receiving step 20, a data conversion step 30, a data storage step 40, an accumulation step 50 and a locating step 60.

In order to obtain an accurate distance measurement between a laser range finder and an object, the emitting step 10 is first performed to emit one laser light pulse, wherein the pulse width of the laser light pulse is from about 10 ns to about 20 ns.

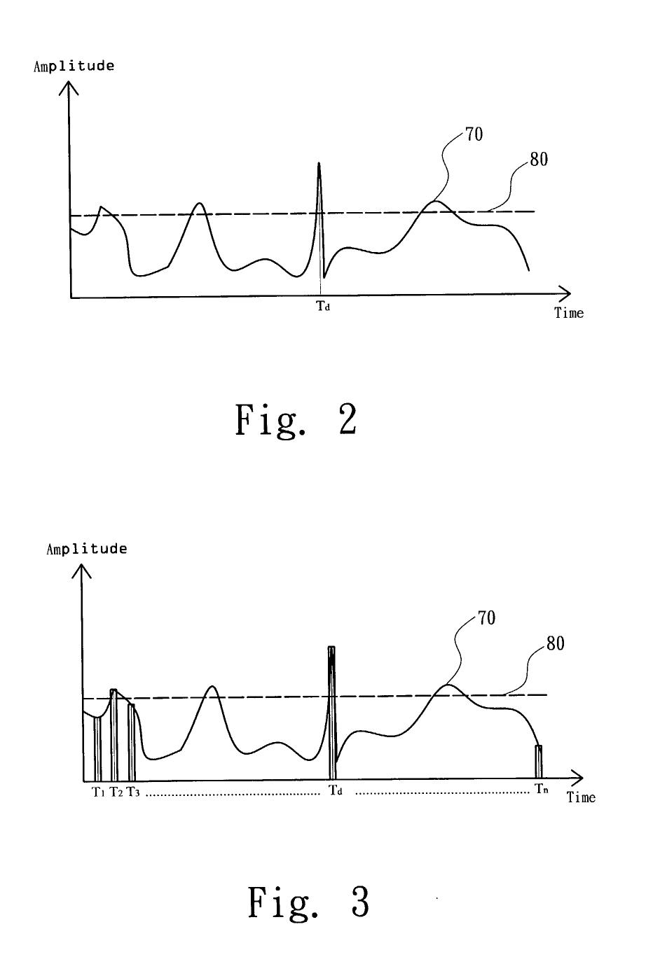

Then the receiving step 20 is performed. A laser receiver of the laser range finder is used to receive an external photo signal that includes not only the reflected laser light pulse, but also stray light, such as sunlight and other photo noises. Thus, by utilizing a feedback control circuit, a threshold voltage 80 (shown in FIG. 2) of the laser receiver can be changed properly, so as to make the laser receiver works with a false alarm for filtering and eliminating the noises caused by sunlight and sunbeam as much as possible.

FIG. 2 is a waveform diagram showing the external photo signal received by the laser receiver. As shown in FIG. 2, the curve 70 of the external photo signal includes the reflected laser light pulse and other noises. Almost all the noise amplitudes reside below the threshold voltage 80 adjusted by the feedback control circuit, but some noise amplitudes still reside above the threshold voltage. The noise amplitudes below the threshold voltage will be filtered/eliminated. Furthermore, the maximum amplitude in the external photo signal may exist at T_{d}, meaning that the laser light pulse spends time T_{d}/2 reaching the measured object according to the formula (1).

After the photo signal is received, the data conversion step 30 is performed, and the photo signal will be transformed into a serial data through proper conversion process, such as photo/electric conversion and A/D signal conversion, wherein the transformation rule thereof is that, the converted value is equal to one if the amplitude of the external photo signal received by the laser receiver is greater than the threshold voltage, and the converted value is zero if the amplitude of the external photo signal received by the laser receiver is less than the threshold voltage. Then, the obtained serial data has to be sampled. According to a measurement sensitivity of the laser range finder, a sampling frequency for sampling the serial data can be determined. For example, if the measurement sensitivity is one meter, the round-trip time needed for laser light to travel the one-way distance of one meter can be determined according to the formula (1), so that the sampling frequency can be known. Thus, according to the sampling frequency, a sampling time Tₛ is determined and obtained, wherein the sampling time Tₛ is equal to T₁, T₂, T₃ . . . Tₙ, T₁ standing for the round-trip time that the laser light pulse needs to travel the one-way distance of one meter; T₂ standing for the round-trip time that the laser light pulse needs to travel the one-way distance of two meters; T₃ standing for the round-trip time that the laser light pulse needs to travel the one-way distance of three meters; Tₙ standing for the round-trip time that the laser light pulse needs to travel the one-way distance of n meters, according to the measurement sensitivity and the formula (1), and n is a variable greater than zero.

Furthermore, the aforementioned sampling time Tₙ is usually defined as the round-trip time needed for the laser light pulse to travel the longest distance mainly according to the emitting power of laser light pulse, wherein the longest distance is the limitative distance for which the laser range finder can be measured.

Hence, for example, if the measurement sensitivity is one meter and the longest measured distance is 1024 meters, the variable n is set to be 1024, and the sampling time T₁₀₂₄ is the round-trip time needed for the laser light pulse to travel the one-way distance of 1024 meters.

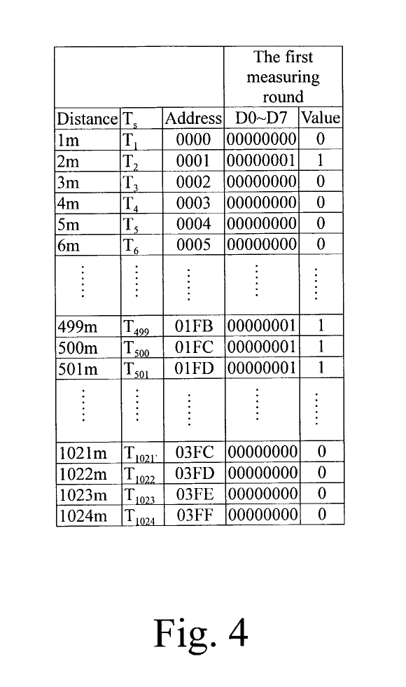

FIG. 3 is a diagram showing the digital data obtained by transforming the photo signal shown in FIG. 2, wherein the sampling time Ts including T₁, T₂, T₃ . . . Tₙ is shown as well. Therefore, by utilizing a data latch module and a register, the serial data is sampled and transformed into a plurality of digital data according to the sampling time Tₛ. For example, if the sampling time Tₛ is counted from T₁ to T₁₀₂₄, sampling processes are performed to the serial data for 1024 times in sequence. Thereafter, 1024 digital data are obtained sequentially, wherein the 1024 digital data correspond to 1024 different distances respectively, just as the aforementioned description about the sampling time Tₛ.

Afterwards, a data storage step 40 is performed to store the 1024 digital data. For example, by utilizing an address decoder and a multiplexer, such as a parallel-to-serial multiplexer, the 1024 digital data are read and processed by a microprocessor, and then are stored into a storage device, such as a memory module.

FIG. 4 schematically shows a plurality of digital data stored in the storage device according to the invention, wherein the emitting step 10, the receiving step 20, the data conversion step 30 and the data storage step 40 have been sequentially performed once. As shown in FIG. 4, a plurality of bits (i.e. eight bits: from D0 to D7) are used to store each digital data in binary code in the storage device, and are respectively represented by an address column. In FIG. 4, a value column illustrates the decimal value of each digital data, and each address corresponds to a distance and sampling time, wherein the distances and the sampling times are mutually correlated, just as the aforementioned description.

Summarily, through the emitting step 10, the receiving step 20, the data conversion step 30 and the data storage step 40, lots of noises in the external photo signal received by the laser receiver are filtered and eliminated by the feedback control circuit controlling the threshold voltage. Then the serial data is obtained by transforming the next photo signal. Afterwards, by utilizing the data latch module and the register, the serial data is sampled and transformed into a plurality of digital data, and by utilizing the address decoder and the multiplexer, all the digital data are read and processed by the microprocessor. Next, all the digital data are stored into the storage device as shown in FIG. 4.

Generally, if the distance measurement is performed in a no-noise situation, only one of the digital data, which is produced by the target, has the value “1”, and the others should have the value “0”. However, since the external photo signal received by the laser receiver is not a pure reflected laser light pulse, and is polluted by noises caused by sunlight or other noise source, so that the digital data stored in the storage device are polluted, i.e. there are more than one digital data having the value “1”. Hence, the microprocessor fails to accurately resolve and distinguish which one of the 1024 digital data corresponds to the correct distance between the laser range finder and the measured object according to the formula (1).

Since noise randomly is existent in space, through statistics, it is known that only the maximum value of the accumulated digital data is obtained and other noises are smaller, while the emitting step 10, the receiving step 20, the data conversion step 30 and the data storage step 40 are sequentially repeated for m times and then accumulatively adding the plurality of digital data obtained later respectively, wherein m is a predetermined integer greater than zero. Therefore, as shown in FIG. 1, the emitting step 10, the receiving step 20, the data conversion step 30, the data storage step 40 and the accumulation step 50 are repeatedly and sequentially performed for m times according to the predetermined integer m, in order to obtain an accumulated result. The accumulated result is generated by accumulatively adding the digital data obtained previously to the digital data obtained at subsequent time, wherein m is an integer equal to or greater than one.

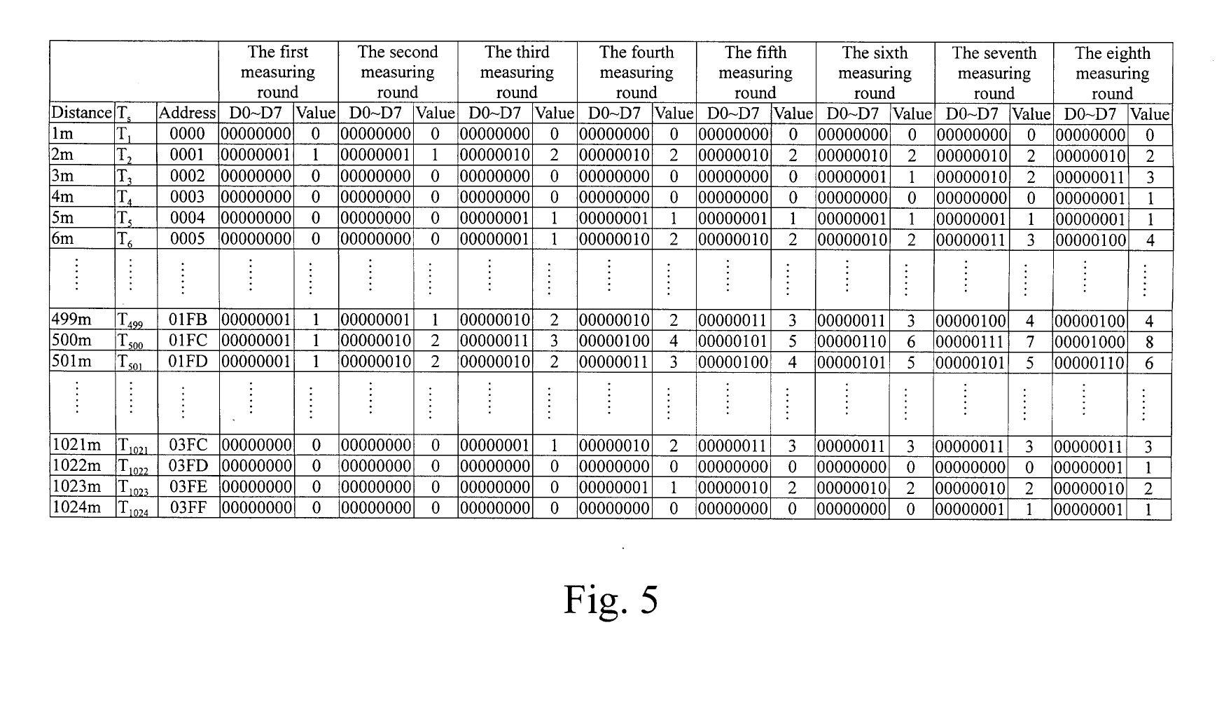

FIG. 5 is a diagram showing the accumulated result by performing eight cycles of the emitting step, the receiving step, the data conversion step, the data storage step and the accumulation step. For example, if the predetermined integer m is set to be eight and the measured object is located at the distance of five hundred meters away from the laser range finder, the emitting step 10, the receiving step 20, the data conversion step 30, the data storage step 40 and the accumulation step 50 are repeated for eight times sequentially. As shown in FIG. 5, since the digital data obtained previously are accumulatively added to the corresponding digital data obtained later in sequence in the accumulation step 50, it is known that the digital data stored at the address 01FC in the storage device has the maximum value “8”. Therefore, in the locating step 60, the microprocessor can accurately resolve and distinguish that the distance between the laser range finder and the measured object is the distance of five hundred meters corresponding to the digital data that is obtained by sampling the serial data at T₅₀₀ and is stored at the address 01FC in the storage device. Then, the measured object is located accurately by the laser range finder according to the method provided by the present invention.

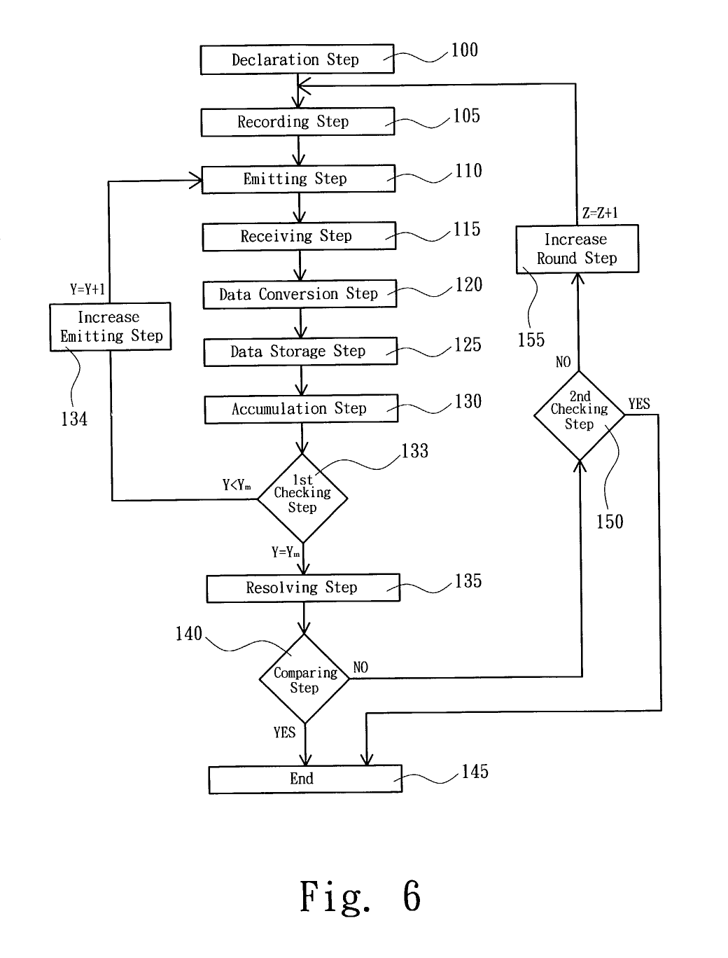

FIG. 6 is another flow chart which is modified from FIG. 1. In order to optimize the embodiment of the invention shown in FIG. 1 for rapidly obtaining accurate measurement results, the invention provides another preferred flow chart. As shown in FIG. 6, a variable Y is declared first in a declaration step 100. A constant Yₘ and a constant Zₘ are also predetermined in the declaration step 100. The variable Y denotes the nth emitting laser in each round, and the constant Yₘ denotes the total emitting times per round, and the constant Zₘ denotes the total rounds. Thus, the variable Y is set to one in the beginning of the declaration step 100.

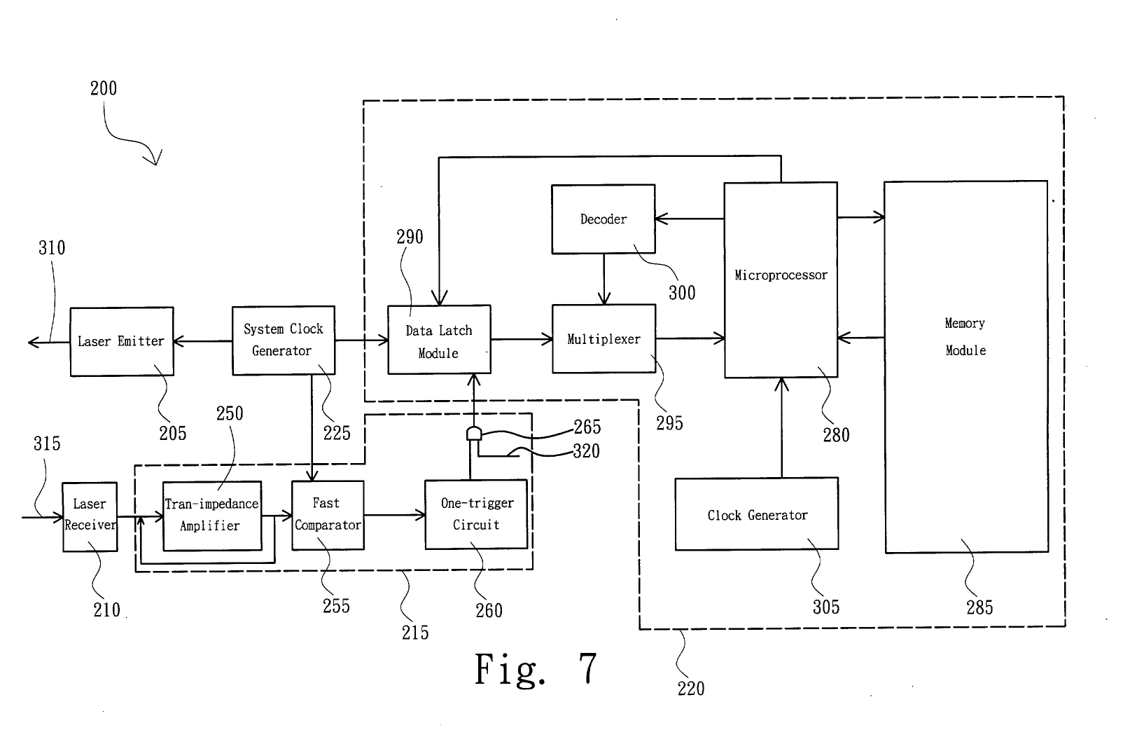

Afterwards, in a recording step 105, a formula (2): X=Yₘ×(Z−1)+Y is used to record total shots of laser light pulses in the flow process of the preferred embodiment of FIG. 6, wherein the variable Z denotes the nth round. Additionally, as the variable Y is equal to Yₘ, the variable Z=Z+1 is counted by a microprocessor (shown in FIG. 7). Accordingly, the range finder performs Zₘ rounds, and emits Yₘ laser beams sequentially in each round.

Hence, according to the aforementioned setting of the variable Y and the variable Z and a result obtained by the variable Z multiplied by the variable Y in the formula (2), the emitting step 110, the receiving step 115, the data conversion step 120, the data storage step 125 and the accumulation step 130 and the first checking step 133 are performed for Yₘ times repeatedly and sequentially in a round of measurement, wherein the operation flow of the emitting step 110, the receiving step 115, the data conversion step 120, the data storage step 125 and the accumulation step 130 is the same as the operation flow of the emitting step 10, the receiving step 20, the data conversion step 30, the data storage step 40 and the accumulation step 50 described as above. Additionally, the first checking step 133 compares the variable Y with the constant Yₘ. If the variable Y is less than the constant Yₘ, an increase emitting step 134 will be executed.

In the increse emitting step 134, a formula (3): Y=Y+1 is used to increase the variable Y for the subsequent emitting of measurement, and the range finder emits the light beam again. If the variable Y is equal to the constant Yₘ, the resolving step 135 is performed next.

After the emitting step 110, the receiving step 115, the data conversion step 120, the data storage step 125 and the accumulation step 130 are performed for Yₘ times repeatedly and sequentially in the first round of measurement, a first accumulated measurement result is obtained by accumulatively adding the digital data obtained previously to the digital data obtained later. In a resolving step 135, one of the digital data having a maximum value in the accumulated measurement result is resolved and obtained by the microprocessor (shown in FIG. 7).

Next, in a comparing step 140, the maximum value divided by the total shots X is compared to a statistic value P. If the maximum value divided by the total shots X is greater than the statistic value P, the measured distance corresponding to the maximum value of the accumulated digital data is obtained and is regarded as the distance between the laser range finder and the measured object. Next, the end step 145 outputs the measured distance. If the maximum value divided by the total shots X is not greater than the statistic value P, a second checking step 150 will be executed. Generally, the statistic value P is approximated to 0.65, as the total shots of laser light pulse in the flow process of FIG. 6 is twenty.

For example, if Yₘ=10, Z=4, P=0.55, and X=40 in the fourth round of measurement, the maximum value divided by forty is compared to 0.55. If the maximum value divided by total shots 40 is greater than 0.55, the measured distance corresponding to the one of the plurality of digital data having the maximum value in the accumulated measurement result is obtained regarded as the distance between the laser range finder and the measured object, and then is forwarded to the end step 145. If the maximum value divided by 40 is not greater than 0.55, a second checking step 150 will be executed.

In the second checking step 150, the variable Z is compared to the total rounds Zₘ mentioned above. If the variable Z is equal to the total rounds Zₘ, the flow process shown in FIG. 6 is forwarded to the end step 145 and shows that the measured object is out of limitation. If the variable Z is less than the total rounds Zₘ, an increase round step 155 will be executed.

In the increase round step 155, a formula (4): Z=Z+1 is used to increase the variable Z for the subsequent round of measurement.

For example, if the constant Zₘ is predetermined to 10 and the variable Z are less than 10, so that the increase round step 155 will be executed. According to the formula (4), as the variable Z becomes 2, and then the variable Z (Z=2) and the constant Yₘ (Yₘ=10) is put into the formula (2) for renewing the total shots X (X=20) in the second round of measurement. Herein, since the variable Z is equal to two, the emitting step 110, the receiving step 115, the data conversion step 120, the data storage step 125 and the accumulation step 130 have been performed for twenty times repeatedly and sequentially.

If the maximum value divided by the total shots X (X=20) is greater than the statistic value P (P=0.65), the measured distance corresponding to the one of the plurality of digital data having the maximum value in the accumulated measurement result is obtained and is regarded as the distance between the laser range finder and the measured object. Next, and the end step 145 outputs the distance.

If the maximum value divided by the total shots X (X=20) is not greater than the statistic value P (P=0.65), the checking step 150 will be executed. If the variable Z is equal to the total rounds Zₘ, the flow process of the preferred embodiment shown in FIG. 6 is forwarded to the end step 145.

In conclusion, through properly setting the variable Z, the variable Y, the statistic value P, the total emitting times Yₘ per round the total rounds Zₘ, the formula (2), the formula (3) and the formula (4), the flow chart shown in FIG. 6 can measure and obtain the distance between the laser range finder and the measured object rapidly without increasing the emitting power of laser light pulse under various situations. Therefore, according to the present invention, the method for locating an object by using a laser range finder is very flexible and simple to be implemented in different applications.

The present invention also provides a laser range finder apparatus as shown in FIG. 7, wherein FIG. 7 is a diagram showing the connection relationship among modules in a preferred embodiment of the apparatus provided by the present invention. The laser range finder apparatus 200 is constituted by a laser emitter 205, a laser receiver 210, a false alarm module 215, a distance measurement and determination module 220 and a system clock generator 225, wherein the false alarm module 215 is constituted by a trans-impedance amplifier 250, a fast comparator 255, an one-trigger circuit 260 and an AND gate 265, and the distance measurement and determination module 220 is constituted by a microprocessor 280, a memory module 285, a data latch module 290, a multiplexer 295, a decoder 300 and a clock generator 305.

According to the aforementioned preferred method provided by the present invention, in a round of measurement, the laser emitter 205 emits one laser light pulse 310, and then a photo signal 315 including the reflected laser light pulse and noises is received by the laser receiver 210. Through the trans-impedance amplifier 250 in the false alarm module 215, a current signal of the photo signal 315 is transformed into a voltage signal. Then, through the fast comparator 255 to control the threshold voltage by utilizing the feedback control circuit, the voltage signal is transformed into a pulse signal to trigger the one-trigger circuit 260 for outputting a serial data to the data latch module 290 in the distance measurement and determination module 220, wherein the AND gate 265 and a trigger signal 320 are utilized as a switch between the one-trigger circuit 260 and the data latch module 290.

After the data latch module 290 receives the serial data from the one-trigger circuit 260, the multiplexer 295 can derived a plurality of digital data from the data latch module 290 by utilizing the microprocessor 280 to control the decoder 300 to output a plurality of decoding address to the multiplexer 295. Then, all the digital data are read and processed (i.e. all the digital data are accumulatively added to all the prior stored digital data) by the microprocessor, and then are stored into the storage device, such as the memory module 285. In addition, the clock generator 305 supplies a main clock for the operation of the microprocessor 280, and the microprocessor 280 controls the system clock generator 225 to supply different clocks to modules and devices in the laser range finder apparatus 200 respectively for operation.

According to the aforementioned preferred method provided by the present invention, through properly setting the variable Z, the variable P, the predetermined number Q, the predetermined number Zₘ, the formula (2) and the formula (3), the microprocessor will perform a plurality of rounds of measurement appropriately for obtaining an accumulative measurement result having the maximum value corresponding to the distance between the laser range finder apparatus 200 and the measured object.

Furthermore, the apparatus provided by the invention is more flexible in design and implementation. Through properly setting the threshold voltage of the false alarm module, lots of noises can be filtered and eliminated. In addition, through increasing the process speed of the microprocessor and the capacity of storage device, such as the capacity of memory module, farther distance away from the laser range finder can be measured and consumption time is decreased. Moreover, the present invention is not limited to the aforementioned embodiments, and can be modified or adjusted appropriately to achieve various applications.

The advantage of the present invention is to provide a method and an apparatus for locating an object by using a laser range finder, and more particularly relates to a method and an apparatus that can increase distance and accuracy of measuring object without increasing laser emitting power. Since noise is randomly existent, there is just only one maximum value in the accumulated measurement result after the laser range finder performs the method of the present invention through the statistics theorem. Hence, the goals of increasing the measuring accuracy and the measurable distance between the laser range finder and the measured object are achieved by only increasing the times of emitting and receiving a laser light pulse but without increasing the emitting laser power. Moreover, the method and the apparatus provided by the present invention have the features of flexible implementation and low cost, so that the present invention has high industrial applicability.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for measuring a distance between a target and a laser range finder, compring the steps of:
performing a plurality of rounds of measurement for obtaining a plurality of measuring results, wherein each of the plurality of rounds of measurement comprises the steps of:
performing an emitting step to emit a laser light pulse;
performing a receiving step to receive a photo signal including the laser light pulse and a plurality of noises;
performing a conversion step comprising the steps of:
transforming the photo signal into a serial signal; and
transforming the serial signal to a plurality of digital signals; and
performing a storage step to store the plurality of digital signals as a measurement result;
performing an accumulation step to accumulatively adding the plurality of measurement results after performing the plurality of rounds of measurement for obtaining an accumulation measurement result; and
performing a determination step to determine a distance between the target and the laser range finder, wherein the distance corresponds to an accumulation parallel digital data having a maximum value in the accumulation measurement result.

2. The method for measuring a distance between a target and a laser range finder according to claim 1, wherein the receiving step further comprises a filtering step to filter and eliminate the plurality of noises.

3. The method for measuring a distance between a target and a laser range finder according to claim 2, wherein the filtering step utilizes a threshold voltage adjusted by a feedback control circuit to filter and eliminate the plurality of noises.

4. The method for measuring a distance between a target and a laser range finder according to claim 1, wherein the laser light pulse has a fixed pulse width.

5. The method for measuring a distance between a target and a laser range finder according to claim 1, wherein the serial digital signal has a fixed pulse width.

6. A method for measuring a distance between a target and a laser range finder, comprising:
performing a declaration step to declare and set a first variable Z, a second variable Y to a first predetermined number and a second predetermined number respectively, wherein the first variable Z denotes the nth round and the second variable Y denotes the nth emitting laser in each round;
performing a recording step to declare a first formula: X=Yₘ×Z, wherein Yₘ is a predetermined value of the total emitting times per round;
according to the first formula X, performing Z rounds of measurement for obtaining C quantities of measuring results, wherein each of the round of measurement comprises the steps of:
performing an emitting step to emit a first laser light pulse;
performing a receiving step to receive a photo signal including the laser light pulse and a plurality of noises;
performing a conversion step comprising the steps of:
transforming the photo signals into a serial signal; and
transforming the serial signal into a plurality of digital signals; and
performing a storage step to store the plurality of digital signals as a measurement result;
performing an accumulation step to accumulatively add the plurality of digital signals for obtaining an accumulation measurement result; and
performing a resolving step to derive one of the plurality of digital signals having a maximum value in the accumulative measurement result;
performing a comparing step, and if the maximum value divided by the X is greater than a predetermined number P, a distance to which the one of the plurality of digital signals having the maximum value corresponds, is between the laser range finder and the target, and if the maximum value divided by the X is not greater than the predetermined number P, a checking step will be executed;
performing the checking step to compare the first variable Z with a predetermined number Zₘ, and if the first variable Z is equal to the predetermined number Zₘ, the method for locating the object by using the laser range finder is forwarded to an ending step, and if the first variable Z is less than the predetermined number Zₘ, an increase round step will be executed; and
performing the increase round step to increase the first variable Z for repeatedly performing the subsequent rounds of measurement for Yₘ times, wherein the next accumulative measurement result is obtained by the increased first variable Z.

7. The method for measuring a distance between a target and a laser range finder according to claim 6, wherein the receiving step further comprises a filtering step to filter and eliminate the plurality of noises.

8. The method for measuring a distance between a target and a laser range finder according to claim 7, wherein the filtering step utilizes a threshold voltage adjusted by a feedback control circuit to filter and eliminate the plurality of noises.

9. The method for measuring a distance between a target and a laser range finder according to claim 6, wherein the laser light pulse has a fixed pulse width.

10. The method for measuring a distance between a target and a laser range finder according to claim 6, wherein the serial signal has a fixed pulse width.

11. An apparatus for measuring a distance between a target and a laser range finder, comprising:
a laser emitter used to emit a laser light pulse;
a laser receiver used to receive a photo signal including a reflected laser light pulse and a plurality of noises;
a false alarm module, which is constituted by a trans-impedance amplifier, a fast comparator and an one-trigger circuit, wherein the trans-impedance amplifier is used to transform the photo signal into a voltage signal, and the fast comparator is used to adjust a threshold voltage to filter and eliminate the plurality of noises, and the one-trigger circuit is used to receive the voltage outputted from the fast comparator and to output a serial data;
a distance measurement and determination module, which is constituted by a microprocessor, a storage device, a data latch module, a multiplexer and a decoder, wherein the microprocessor controls the data latch module and the multiplexer through the decoder to let the serial data, which is received and transformed into a plurality of digital data by the data latch module and the multiplexer, and then the plurality of digital data are stored in the storage device; and
a system clock generator, which is controlled by the microprocessor to supply a plurality of clocks to the laser emitter, the laser receiver and the data latch module.

12. The apparatus for measuring a distance between a target and a laser range finder according to claim 11, wherein the storage device is a memory module.

13. The apparatus for measuring a distance between a target and a laser range finder according to claim 11, wherein the distance measurement and determination module further comprises a clock generator used to supply a main clock to the microprocessor.

14. The apparatus for measuring a distance between a target and a laser range finder according to claim 11, wherein the false alarm module further comprises an AND gate used as switch between the one-trigger circuit and the data latch module.
